(19) United States
(12) Patent Application Publication
(10) Pub. No.: US 2026/0180145 A1
(43) Pub. Date: Jun. 25, 2026

(54) POSITIVE ELECTRODE FOR SOLID STATE BATTERY, MANUFACTURING METHOD OF THE SAME, SOLID STATE BATTERY INCLUDING THE SAME

(71) Applicant: POSCO Holdings Inc., Pohang-si (KR)

(72) Inventors: Seungdeok SEO, Pohang-si (KR); Ohmin KWON, Pohang-si (KR); Gwangseok OH, Pohang-si (KR); Min Jae YOU, Pohang-si (KR); Sang-Cheol NAM, Pohang-si (KR)

(73) Assignee: POSCO Holdings Inc., Pohang-si (KR)

(21) Appl. No.: 19/422,862

(22) Filed: Dec. 17, 2025

(30) Foreign Application Priority Data
Dec. 19, 2024 (KR) 10-2024-0190911

(51) Int. Cl. H01M 50/586; H01M 4/02; H01M 50/42; H01M 50/474

(52) U.S. Cl. CPC H01M 50/586; H01M 50/42; H01M 50/474; H01M 2004/028

(57) ABSTRACT

The present invention relates to a positive electrode for an all-solid-state battery, a method for manufacturing the same, and an all-solid-state battery comprising the same, wherein the positive electrode for an all-solid-state battery comprises a positive electrode layer and a short-circuit prevention layer surrounding an edge portion of the positive electrode layer, and wherein the short-circuit prevention layer comprises a UV curable polymer.

### TECHNICAL FIELD

This application claims priority to Korean Patent Application No. 10-2024-0190911 filed on Dec. 19, 2024, the entire contents of which are incorporated herein by reference.

The present invention relates to a positive electrode for an all-solid-state battery, a method for manufacturing the same, and an all-solid-state battery comprising the same.

### BACKGROUND ART

The present invention is a result derived from the following research project.
(Project Name) High-power and high-safety all-solid-state secondary battery technology for multi-purpose unmanned vehicles
(Project Number) 22-CM-FC-20
(Ministry) Ministry of Trade, Industry and Energy; Defense Acquisition Program Administration
(Management (Specialized) Agency) Institute of Civil-Military Technology Cooperation
(Research Business Name) Civil-Military Technology Development Project
(Contribution Rate) 1/1
(Project Performing Institution) Electronics and Telecommunications Research Institute
(Research Period) 2024.1.1˜2024.12.31

All-solid-state batteries, which use a solid electrolyte instead of a liquid electrolyte as an electrolyte, are attracting attention as next-generation batteries because they exhibit high safety and can improve energy density.

In order to maintain the performance of an all-solid-state battery, it is necessary to suppress degradation caused by a volume change of a positive electrode during battery operation, while preventing an unexpected short circuit from occurring due to pressure applied between upper and lower electrodes after battery assembly.

### DISCLOSURE

### Technical Problem

One embodiment is to provide a positive electrode for an all-solid-state battery that suppresses degradation caused by a volume change of the positive electrode during battery operation and prevents an unexpected short circuit from occurring due to pressure applied between upper and lower electrodes after battery assembly.

### Technical Solution

One embodiment provides a positive electrode for an all-solid-state battery comprising a positive electrode layer and a short-circuit prevention layer surrounding an edge portion of the positive electrode layer, wherein the short-circuit prevention layer comprises a UV curable polymer.

### Advantageous Effects

The positive electrode for an all-solid-state battery according to one embodiment can suppress degradation caused by a volume change of the positive electrode during battery operation and prevent an unexpected short circuit from occurring due to pressure applied between upper and lower electrodes after battery assembly.

### DESCRIPTION OF DRAWINGS

FIG. 1 is a schematic diagram of a positive electrode manufactured according to one embodiment.

FIG. 2 shows life evaluation results according to Evaluation Example 1.

FIG. 3 is a conceptual diagram showing the correlation between the thickness of a short-circuit prevention layer and a positive electrode.

### BEST MODE

Terms such as first, second, and third are used to describe various parts, components, regions, layers, and/or sections, but are not limited thereto. These terms are only used to distinguish one part, component, region, layer, or section from another part, component, region, layer, or section. Accordingly, a first part, component, region, layer, or section described below may be referred to as a second part, component, region, layer, or section without departing from the scope of the present invention.

The terminology used herein is for the purpose of describing particular embodiments only and is not intended to be limiting of the present invention. As used herein, the singular forms are intended to include the plural forms as well, unless the context clearly indicates otherwise. The meaning of “comprising” or “including” used in the specification specifies specific characteristics, regions, integers, steps, operations, elements, and/or components, but does not exclude the presence or addition of other characteristics, regions, integers, steps, operations, elements, and/or components.

When a part is referred to as being “on” or “above” another part, it may be directly on or above the other part, or intervening parts may be present therebetween. In contrast, when a part is referred to as being “directly on” another part, there are no intervening parts present therebetween.

Unless otherwise defined, all terms including technical and scientific terms used herein have the same meaning as commonly understood by one of ordinary skill in the art to which the present invention belongs. Terms defined in commonly used dictionaries are to be further interpreted as having a meaning consistent with the relevant technical literature and the present disclosure, and are not to be interpreted in an ideal or overly formal sense unless defined otherwise.

In addition, unless otherwise specified, % means % by weight, and 1 ppm is 0.0001% by weight.

In the present specification, the term “combination(s) thereof” described in a Markush-type expression means a mixture or combination of one or more selected from the group consisting of the components described in the Markush-type expression, and means including any one or more selected from the group consisting of the components.

Hereinafter, embodiments of the present invention will be described in detail so that those skilled in the art can easily practice the present invention. However, the present invention may be embodied in many different forms and is not limited to the embodiments described herein.

### (Positive Electrode for All-Solid-State Battery)

One embodiment provides a positive electrode for an all-solid-state battery comprising a positive electrode layer and a short-circuit prevention layer surrounding an edge portion of the positive electrode layer, wherein the short-circuit prevention layer comprises a UV curable polymer.

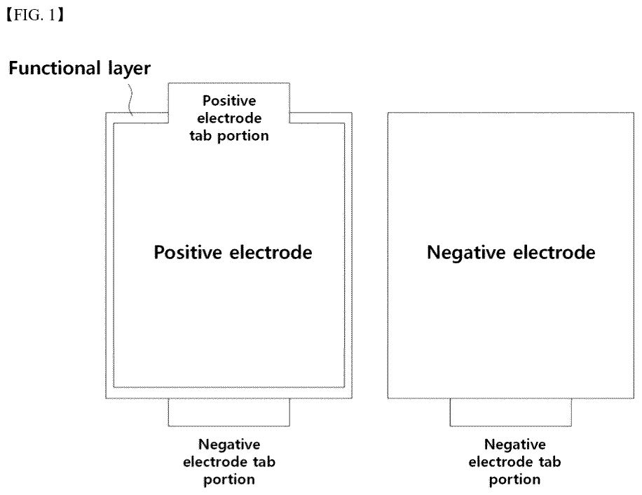

FIG. 1 is a schematic diagram of a positive electrode manufactured according to one embodiment.

As shown in FIG. 1, the short-circuit prevention layer surrounding the edge portion of the positive electrode layer can directly prevent a short circuit that may occur during cell assembly and pressurization. In addition, the short-circuit prevention layer surrounding the edge portion of the positive electrode layer serves to suppress the collapse of the positive electrode active material layer by relieving stress concentration caused by a volume change of the positive electrode during the operation of the all-solid-state battery, thereby improving the life of the all-solid-state battery in the long term.

In summary, the positive electrode for an all-solid-state battery according to one embodiment can suppress degradation caused by a volume change of the positive electrode during battery operation, while preventing an unexpected short circuit from occurring due to pressure applied between upper and lower electrodes after battery assembly.

The UV curable polymer may be a polymer of a raw material mixture comprising an oligomer and a monomer.

The UV curable polymer may be one in which the raw material mixture comprising the oligomer and the monomer is polymerized and cured by UV irradiation in the presence of a photopolymerization initiator.

The polymerization method may be radical polymerization or cationic polymerization, and the types of raw materials used may differ depending on the polymerization method.

For example, in the radical polymerization, the oligomer may be an acrylate-based oligomer (e.g., polyester, epoxy, urethane, polyether, silicone, etc.), the monomer may be a monofunctional monomer, a polyfunctional monomer, or a combination thereof, and the photopolymerization initiator may be benzoin ethers, amines, or a combination thereof. Additives such as an adhesion promoter, a filler, and a polymerization inhibitor may be added thereto.

Alternatively, in the cationic polymerization, the oligomer may be a cycloaliphatic epoxy resin, a glycidyl ether epoxy resin, an epoxy acrylate, a vinyl ether, or a combination thereof, the monomer may be an epoxy-based monomer, vinyl ethers, cyclic ethers, or a combination thereof, and the photopolymerization initiator may be a diazonium salt, an iodonium salt, a sulfonium salt, a metallocene compound, or a combination thereof. Additives such as a silane coupling agent may be added thereto.

The thickness of the short-circuit prevention layer may be equal to or greater than the thickness of the positive electrode layer.

When the thickness per one surface of the positive electrode layer is a μm, the thickness of the short-circuit prevention layer is set to at least a μm, thereby blocking the loss of the electrode mixture and the separator layer and problems resulting therefrom due to a step difference generated between electrodes.

However, since there is a high possibility that shrinkage after curing proceeds as described above, coating is performed with a margin of about 1 to 10 thickness %.

For example, when the positive electrode layer thickness is a2 μm, the short-circuit prevention layer coating thickness before curing may be a2×100×b2. Here, a2 may be 5 to 200 μm, and b2 may be 1 to 10 thickness %.

As another example, when the thickness of the positive electrode layer is $a1$, the final thickness of the short-circuit prevention layer after curing may be (5+a1) μm to (200+a1) μm, wherein a1 may be 5 to 200 μm.

The positive electrode layer may comprise a positive electrode current collector and a positive electrode active material layer positioned on one surface or both surfaces of the positive electrode current collector.

The positive electrode active material layer may further comprise, for example, a positive electrode active material and optionally a solid electrolyte as needed. The solid electrolyte included in the positive electrode active material layer may be the same as or different from the solid electrolyte according to one embodiment of the present invention, and may be the same as or different from the solid electrolyte included in the solid electrolyte layer.

The positive electrode active material is a material capable of reversibly absorbing and desorbing lithium ions. The positive electrode active material may be, for example, a lithium transition metal oxide such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate, nickel sulfide, copper sulfide, lithium sulfide, iron oxide, or vanadium oxide, but is not necessarily limited thereto, and any material used as a positive electrode active material in the art may be used. The positive electrode active materials may be used alone or as a mixture of two or more.

The lithium transition metal oxide is, for example, a compound represented by any one of the following chemical formulas:
LiₐA_{1-b}B_{b}D₂ (0.90≤a≤1, 0≤b≤0.5); LiₐE_{1-b}B_{b}O_{2-c}D_{c} (0.90≤a≤1, 0≤b≤0.5, 0≤c≤0.05); LiE_{2-b}B_{b}O_{4-c}D_{c} (0≤b≤0.5, 0≤c≤0.05); LiₐNi_{1-b-c}Co_{b}B_{c}D_{α} (0.90≤a≤1, 0≤b≤0.5, 0≤c≤0.05, 0<α<2); LiₐNi_{1-b-c}Co_{b}B_{c}O_{2-α}F_{α} (0.90≤a≤1, 0≤b≤0.5, 0≤c≤0.05, 0<α<2); LiₐNi_{1-b-c}Co_{b}B_{c}O_{2-α}F₂ (0.90≤a≤1, 0≤b≤0.5, 0≤c≤0.05, 0<α<2); LiₐNi_{1-b-c}Mn_{b}B_{c}D_{α} (0.90≤a≤1, 0≤b≤0.5, 0≤c≤0.05, 0<α≤2); LiₐNi_{1-b-c}Mn_{b}B_{c}O_{2-α}F_{α} (0.90≤a≤1, 0≤b≤0.5, 0≤c≤0.05, 0<α<2); LiₐNi_{1-b-c}Mn_{b}B_{c}O_{2-α}F₂ (0.90≤a≤1, 0≤b≤0.5, 0≤c≤0.05, 0<α<2); LiₐNi_{b}E_{c}G_{d}O₂ (0.90≤a≤1, 0≤b≤0.9, 0≤c≤0.5, 0.001≤d≤0.1); LiₐNi_{b}Co_{c}Mn_{d}GeO₂ (0.90≤a≤1, 0≤b≤0.9, 0≤c≤0.5, 0≤d≤0.5, 0.001≤e≤0.1); LiₐNiG_{b}O₂ (0.90≤a≤1, 0.001≤b≤0.1); LiₐCoG_{b}O₂ (0.90≤a≤1, 0.001≤b≤0.1); LiₐMnG_{b}O₂ (0.90≤a≤1, 0.001≤b≤0.1); LiₐMn₂G_{b}O₄ (0.90≤a≤1, 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); LiFePO₄

In these formulas, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof, and J is V, Cr, Mn, Co, Ni, Cu, or a combination thereof.

A compound having a coating layer added to the surface of these compounds may be used, and a mixture of the aforementioned compound and a compound having a coating layer added thereto may also be used.

The coating layer added to the surface of such a compound comprises, for example, a coating element compound of an oxide, hydroxide, oxyhydroxide, oxycarbonate, or hydroxycarbonate of a coating element.

The compound constituting such a coating layer is amorphous or crystalline. The coating element included in the coating layer is Mg, Al, Co, K, Na, Ca, Si, Ti, V, Sn, Ge, Ga, B, As, Zr, or a mixture thereof.

The method of forming the coating layer is selected within a range that does not adversely affect the physical properties of the positive electrode active material. The coating method is, for example, spray coating, dipping, etc. Since specific coating methods are well understood by those skilled in the art, detailed description thereof will be omitted.

The positive electrode active material layer may comprise, for example, a binder. The binder includes, for example, styrene butadiene rubber (SBR), polytetrafluoroethylene, polyvinylidene fluoride, polyethylene, etc., but is not limited thereto, and any material used as a binder in the art may be used. The positive electrode active material layer may comprise, for example, a conductive material.

The conductive material includes, for example, graphite, carbon black, acetylene black, Ketjen black, carbon fiber, metal powder, etc., but is not limited thereto, and any material used as a conductive material in the art may be used. The positive electrode active material layer may further comprise additives such as a filler, a coating agent, a dispersant, and an ion-conductive auxiliary agent in addition to the aforementioned positive electrode active material, solid electrolyte, binder, and conductive material.

As the filler, coating agent, dispersant, ion-conductive auxiliary agent, etc. that may be included in the positive electrode active material layer, known materials generally used in electrodes of all-solid-state secondary batteries may be used. The positive electrode current collector may use, for example, a plate or foil made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The thickness of the positive electrode current collector may be, for example, 1 μm to 100 μm, 1 μm to 50 μm, 5 μm to 25 μm, or 10 μm to 20 μm.

(Method for Manufacturing Positive Electrode for all-Solid-State Battery)

Another embodiment provides a method for manufacturing a positive electrode for an all-solid-state battery, comprising: applying a composition comprising a UV curable monomer to an edge portion of a positive electrode layer; and irradiating UV onto the edge portion of the positive electrode layer to which the composition comprising the UV curable monomer has been applied, thereby converting the composition comprising the UV curable monomer into a short-circuit prevention layer comprising a UV curable polymer.

This may be a method for manufacturing the positive electrode of the aforementioned embodiment.

The applying may be performed using a dispenser. For example, after inserting the UV curable raw material mixture into a pressure tank provided in the dispenser, the UV curable raw material mixture may be applied to the edge portion of the positive electrode layer while controlling a discharge amount by pressurizing the pressure tank to a pressure of less than 1 MPa using an air compressor.

A coating width during the discharging may be determined by a diameter of a tube end nozzle extending from the pressure tank. In this case, the application may proceed while a fixed amount of the UV curable raw material mixture is discharged, moving at a fixed position or by a movement of a pre-learned robot arm.

In order to form the short-circuit prevention layer for surrounding the edge portion of the positive electrode layer, the applying may be performed using a dispenser to fit an area of a positive electrode edge manufactured to have an appropriate uncoated region margin. Immediately after application by discharging the UV curable raw material mixture, polymerization and curing may be performed using a UV lamp (e.g., HeXe Lamp) capable of output adjustment up to a maximum of 250 W.

### (All-Solid-State Battery)

Another embodiment provides an all-solid-state battery comprising: the positive electrode of the aforementioned embodiment; a negative electrode; and a solid electrolyte layer positioned between the positive electrode and the negative electrode.

Hereinafter, descriptions overlapping with the foregoing will be omitted, and the all-solid-state battery according to one embodiment will be described in detail.

### (Negative Electrode)

More specifically, the negative electrode may comprise a negative electrode current collector and a negative electrode active material layer disposed on the negative electrode current collector.

The negative electrode active material layer may comprise, for example, a negative electrode active material and a binder, and may optionally further comprise a solid electrolyte as needed.

The negative electrode active material may comprise, for example, a carbon-based negative electrode active material, a metal/semi-metal negative electrode active material, or a combination thereof. The carbon-based negative electrode active material may be amorphous carbon, crystalline carbon, or a mixture or composite thereof.

The amorphous carbon includes, for example, carbon black (CB), acetylene black (AB), furnace black (FB), Ketjen black (KB), graphene, etc., but is not necessarily limited thereto, and any material classified as amorphous carbon in the art may be used.

Amorphous carbon is carbon having no crystallinity or very low crystallinity, and is distinguished from crystalline carbon or graphite-based carbon.

The crystalline carbon may be, for example, natural graphite, artificial graphite, or a combination thereof.

The metal/semi-metal negative electrode active material includes at least one selected from the group consisting of lithium (Li), gold (Au), platinum (Pt), palladium (Pd), silicon (Si), silver (Ag), aluminum (Al), bismuth (Bi), tin (Sn), and zinc (Zn), but is not necessarily limited thereto, and any material used as a metal negative electrode active material or semi-metal negative electrode active material forming an alloy or compound with lithium in the art may be used.

The binder included in the negative electrode active material layer includes, for example, styrene-butadiene rubber (SBR), polytetrafluoroethylene, polyvinylidene fluoride, polyethylene, vinylidene fluoride/hexafluoropropylene copolymer, polyacrylonitrile, polymethylmethacrylate, etc., but is not necessarily limited thereto, and any material used as a binder in the art may be used. The binder may be composed of a single binder or a plurality of different binders.

By including the binder in the negative electrode active material layer, the negative electrode active material layer is stabilized on the negative electrode current collector. In addition, cracking of the negative electrode active material layer is suppressed despite a volume change and/or a relative position change of the negative electrode active material layer during charge and discharge processes.

The negative electrode active material layer may further comprise additives used in conventional all-solid-state batteries, for example, a filler, a coating agent, a dispersant, an ion-conductive auxiliary agent, and the like.

The all-solid-state battery may further comprise a second negative electrode active material layer disposed between the negative electrode current collector and the negative electrode active material layer by charging. The second negative electrode active material layer may be deposited between the negative electrode current collector and the negative electrode active material layer during a charging process, or may be further disposed on the negative electrode active material layer during electrode assembly.

This second negative electrode active material layer may be a metal layer comprising lithium or a lithium alloy. The lithium alloy includes, for example, a Li—Al alloy, a Li—Sn alloy, a Li—In alloy, a Li—Ag alloy, a Li—Au alloy, a Li—Zn alloy, a Li—Ge alloy, a Li—Si alloy, etc., but is not limited thereto, and any material used as a lithium alloy in the art may be used.

The second negative electrode active material layer may consist of one of these alloys and/or lithium, or may consist of various types of alloys and/or lithium. The negative electrode current collector may be composed of, for example, a material that does not react with lithium, that is, does not form both an alloy and a compound.

The negative electrode current collector may comprise, for example, copper (Cu), stainless steel, titanium (Ti), iron (Fe), cobalt (Co), nickel (Ni), etc., but is not necessarily limited thereto, and any material used as an electrode current collector in the art may be used. The negative electrode current collector may be composed of one of the aforementioned metals, or may be composed of an alloy or coating material of two or more metals.

The negative electrode current collector may be in the form of, for example, a plate or a foil. When the negative electrode active material layer comprises a solid electrolyte, the solid electrolyte included in the negative electrode active material layer may be the same as or different from the solid electrolyte according to one embodiment of the present invention, and may be the same as or different from the solid electrolyte included in the solid electrolyte layer.

### (Solid Electrolyte Layer)

The solid electrolyte layer may be manufactured by mixing and drying the aforementioned solid electrolyte and a binder, or may be manufactured by rolling the aforementioned solid electrolyte powder into a certain shape at a pressure of 1 ton to 10 tons.

In this case, the solid electrolyte may be in the form of a powder or a molded body. The solid electrolyte in the form of a molded body may be, for example, in the form of a pellet, a sheet, a thin film, etc., but is not necessarily limited thereto and may have various forms depending on the intended use.

The solid electrolyte layer may further comprise, if necessary, a solid electrolyte such as a conventional sulfide-based solid electrolyte and/or an oxide-based solid electrolyte in addition to the aforementioned solid electrolyte.

The binder includes, for example, styrene butadiene rubber (SBR), polytetrafluoroethylene, polyvinylidene fluoride, polyethylene, polyvinyl alcohol, etc., but is not limited thereto, and any material used as a binder in the art may be used. The binder of the solid electrolyte layer may be the same as or different from the binders of the positive electrode layer and the negative electrode layer.

### (All-Solid-State Battery Assembly)

A lead tab is welded to each electrode manufactured by the above method, and then stacked together with a separator layer to assemble an all-solid-state battery. The all-solid-state battery assembly may be performed by stacking in the order of positive electrode/separator/negative electrode, and inserting and sealing in an Al—PP based composite-based pouch. Thereafter, a pressure of 350 MPa or more may be applied through a Warm Isostatic Press (WIP) method to maximize densification of the electrode mixture and contact between electrode/separator/electrode. However, this is merely an example, and assembly is possible by methods other than the above method.

Hereinafter, embodiments of the present invention will be described in more detail through examples. However, the following examples are merely preferred embodiments of the present invention, and the present invention is not limited to the following examples.

### Example 1

### (1) Manufacturing of Positive Electrode

A positive electrode layer having a thickness of 50 μm and including an uncoated region of about 5 mm in each of a length direction and a width direction at an edge portion was prepared.

A commercially available polyacrylate-based raw material mixture (Loctite 5883) was used as the UV curable raw material mixture.

After inserting the UV curable raw material mixture into a pressure tank provided in a dispenser, the UV curable raw material mixture was applied to the edge portion of the positive electrode layer while controlling a discharge amount by pressurizing the pressure tank to a pressure of less than 1 MPa using an air compressor.

Since a coating width during the discharging can be determined by a diameter of a tube end nozzle extending from the pressure tank, the application was allowed to proceed while a fixed amount of the UV curable raw material mixture was discharged, moving at a fixed position or by a movement of a pre-learned robot arm.

In order to form a short-circuit prevention layer for surrounding the edge portion of the positive electrode layer, application was performed to a thickness of 50 μm using a dispenser on the positive electrode edge portion manufactured to have an appropriate uncoated region margin.

Immediately after application by discharging of the UV curable raw material mixture, polymerization and curing were performed using a UV lamp (e.g., HeXe Lamp) capable of output adjustment up to a maximum of 250 W. Accordingly, a positive electrode for an all-solid-state battery, in which a short-circuit prevention layer having a thickness of 50 μm was formed on the edge portion of the positive electrode layer, was obtained.

(2) Manufacturing of all-Solid-State Battery

A solid electrolyte layer functioning as a separator was coated on a Li-metal negative electrode (thickness: 30 μm), a tab was attached to the negative electrode/separator laminate, and then the positive electrode was stacked on the separator of the negative electrode/separator laminate.

It was enclosed in a commercially available pouch made of aluminum-polypropylene material and sealed, and then pressurized at 450 MPa using a warm isostatic press (WIP) to manufacture an all-solid-state battery.

### Example 2

A positive electrode for an all-solid-state battery and an all-solid-state battery were manufactured in the same manner as in Example 1, except that the thickness of the short-circuit prevention layer was changed to 40 μm.

### Example 3

A positive electrode for an all-solid-state battery and an all-solid-state battery were manufactured in the same manner as in Example 1, except that the thickness of the short-circuit prevention layer was changed to 45 μm.

### Example 4

A positive electrode for an all-solid-state battery and an all-solid-state battery were manufactured in the same manner as in Example 1, except that the thickness of the short-circuit prevention layer was changed to 55 μm.

### Example 5

A positive electrode for an all-solid-state battery and an all-solid-state battery were manufactured in the same manner as in Example 1, except that the thickness of the short-circuit prevention layer was changed to 60 μm.

### Comparative Example 1

An all-solid-state battery was manufactured using a positive electrode in which the short-circuit prevention layer was not formed at all.

### Evaluation Example 1: Life Evaluation

For the all-solid-state batteries of Example 1 and Comparative Example 1, charging and discharging were performed once by a constant current-constant voltage method at a current density of 0.1 C (formation charge/discharge).

Thereafter, a charge cut-off voltage was set to 4.2 V, and a charge cut-off current was set to a current of 0.02 C, and charging was performed at 0.5 C.

During discharging, discharging was performed by a 0.5 C constant current method, and a discharge cut-off voltage was set to 1.9 V.

Taking this as one cycle, a total of 99 cycles of charging and discharging were performed excluding the formation charge/discharge.

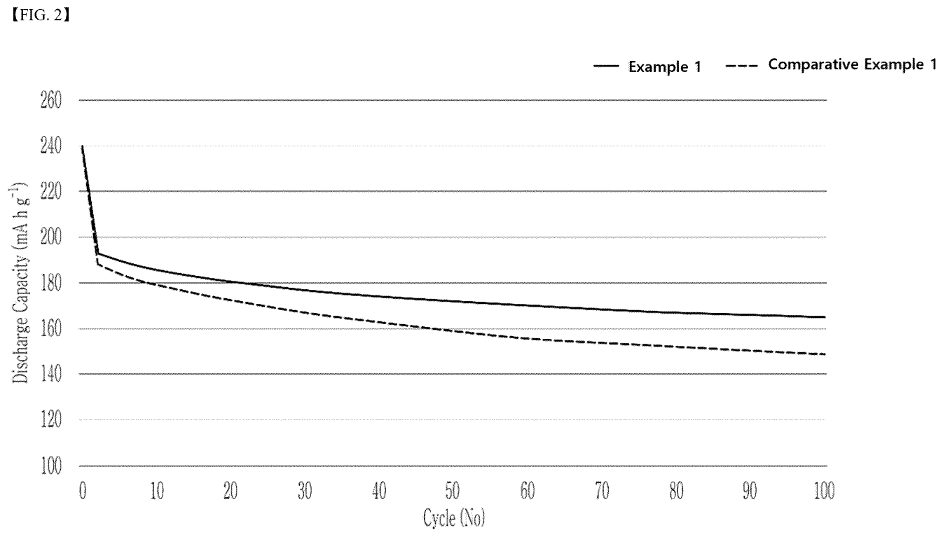

FIG. 2 shows life evaluation results according to Evaluation Example 1.

### Evaluation Example 2: Evaluation of Characteristics Before and After Storage

For the all-solid-state batteries of Example 1 and Comparative Example 1, storage was performed under the following conditions, and voltage before storage (SOC 100%), voltage after storage (%), 1st cycle discharge capacity (based on 100% of Example 1 discharge capacity), and capacity after storage for 100 hours (%, based on 1st cycle discharge capacity of Example 1) were measured, and the results are shown in Table 1 below.

Before storage: 4.2 V charged state after performing 1 cycle of charge/discharge

After storage: Stored in a 55° C. chamber for 100 hours.

TABLE 1

| | | | | | Capacity after |
|---|---|---|---|---|---|
| | | | | | storage for 100 |
| | | | | 1st cycle discharge | hours (%, based |
| | Short-circuit | Voltage before | | capacity (based on | on 1st cycle |
| | prevention | storage | Voltage after | 100% of Example 1 | discharge capacity |
| | layer (μm) | (SOC 100%) | storage (%) | discharge capacity) | of Example 1) |
| Example 1 | 50 | 4.2 | 88.3% | 100% | 95.0% |
| Example 2 | 40 | 4.2 | 81.6% | 99.5% | 92.1% |
| Example 3 | 45 | 4.2 | 83.1% | 99.3% | 93.2% |
| Example 4 | 55 | 4.2 | 85.5% | 96.2% | 91.2% |
| Example 5 | 60 | 4.2 | 87.0% | 97.8% | 89.1% |
| Comparative | 0 | 4.2 | 80.3% | 101.2% | 79.9% |
| Example 1 | (Not applied) | | | | |

The positive electrode for an all-solid-state battery according to one embodiment represented by Examples 1 to 5 can suppress degradation caused by a volume change of the positive electrode during battery operation, while preventing an unexpected short circuit from occurring due to pressure applied between upper and lower electrodes after battery assembly.

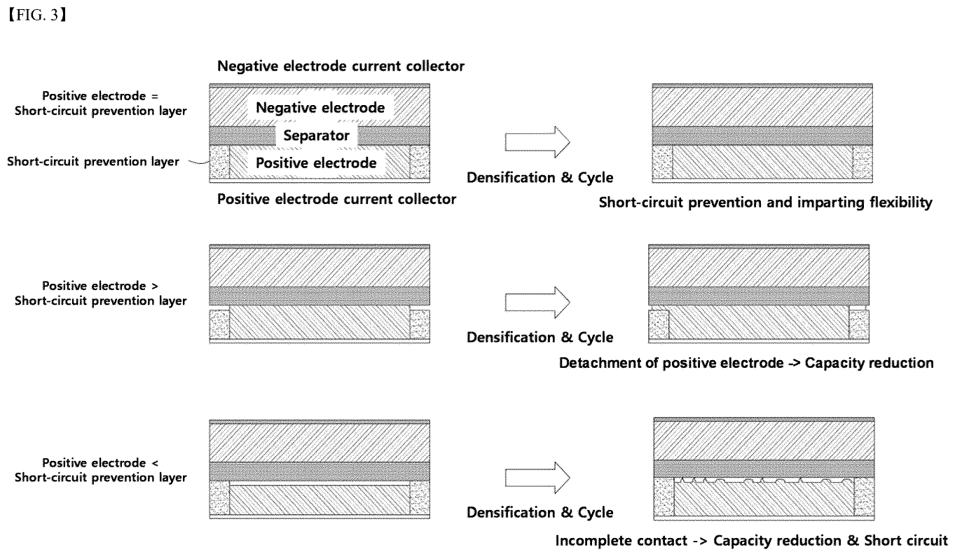

FIG. 3 is a conceptual diagram showing a correlation between a thickness of the short-circuit prevention layer and a thickness of the positive electrode mixture.

When a short-circuit prevention layer of an appropriate thickness is not inserted, partial self-discharge and capacity loss phenomena may occur due to unstable formation of an electrode interface or detachment of a positive electrode active material, etc., and this can be confirmed through trends of voltage drop and capacity reduction during storage of a fully charged cell.

Although preferred embodiments of the present invention have been described above, the present invention is not limited thereto, and various modifications may be made within the scope of the claims, the detailed description of the invention, and the accompanying drawings, and it is obvious that these also fall within the scope of the present invention.

Therefore, the substantial scope of the present invention will be defined by the appended claims and their equivalents.

1. A positive electrode for an all-solid-state battery, comprising: a positive electrode layer; and a short-circuit prevention layer surrounding an edge portion of the positive electrode layer, wherein the short-circuit prevention layer comprises a UV curable polymer.

2. The positive electrode for an all-solid-state battery of claim 1, wherein the UV curable polymer is a polymer of a raw material mixture comprising an oligomer and a monomer.

3. The positive electrode for an all-solid-state battery of claim 2, wherein the raw material mixture comprising the oligomer and the monomer is polymerized and cured by UV irradiation in the presence of a photopolymerization initiator.

4. The positive electrode for an all-solid-state battery of claim 3, wherein the polymerization method is radical polymerization or cationic polymerization.

5. The positive electrode for an all-solid-state battery of claim 4, wherein, in the radical polymerization, the oligomer is an acrylate-based oligomer, the monomer is a monofunctional monomer, a polyfunctional monomer, or a combination thereof, and the photopolymerization initiator is benzoin ethers, amines, or a combination thereof.

6. The positive electrode for an all-solid-state battery of claim 4, wherein, in the cationic polymerization, the oligomer is a cycloaliphatic epoxy resin, a glycidyl ether epoxy resin, an epoxy acrylate, a vinyl ether, or a combination thereof, the monomer is an epoxy-based monomer, vinyl ethers, cyclic ethers, or a combination thereof, and the photopolymerization initiator is a diazonium salt, an iodonium salt, a sulfonium salt, a metallocene compound, or a combination thereof.

7. The positive electrode for an all-solid-state battery of claim 1, wherein a thickness of the short-circuit prevention layer is equal to or greater than a thickness of the positive electrode layer.

8. The positive electrode for an all-solid-state battery of claim 7, wherein, when the thickness of the positive electrode layer is a1, the thickness of the short-circuit prevention layer is (5+a1) μm to (200+a1) μm, wherein a1 is 5 μm to 200 μm.

9. The positive electrode for an all-solid-state battery of claim 1, wherein the positive electrode layer comprises a positive electrode current collector and a positive electrode active material layer positioned on one surface or both surfaces of the positive electrode current collector.

10. A method for manufacturing a positive electrode for an all-solid-state battery, comprising: applying a UV curable raw material mixture to an edge portion of a positive electrode layer; and irradiating UV onto the edge portion of the positive electrode layer to which the UV curable raw material mixture has been applied.

11. The method for manufacturing a positive electrode for an all-solid-state battery of claim 10, wherein the UV curable raw material mixture comprises: a raw material mixture comprising an oligomer and a monomer; and a photopolymerization initiator.

12. The method for manufacturing a positive electrode for an all-solid-state battery of claim 10, wherein the applying is performed using a dispenser.

13. The method for manufacturing a positive electrode for an all-solid-state battery of claim 10, wherein the applying comprises: inserting the UV curable raw material mixture into a pressure tank provided in the dispenser; and applying the UV curable raw material mixture to the edge portion of the positive electrode layer while controlling a discharge amount by pressurizing the pressure tank at less than 1 MPa using an air compressor.

14. The method for manufacturing a positive electrode for an all-solid-state battery of claim 10, wherein, in the irradiating of UV, a UV lamp capable of output adjustment up to a maximum of 250 W is used.

15. An all-solid-state battery comprising: the positive electrode according to claim 1; a negative electrode; and a solid electrolyte layer positioned between the positive electrode and the negative electrode.
